(19) United States
(12) Patent Application Publication
(10) Pub. No.: US 2017/0361277 A1
(43) Pub. Date: Dec. 21, 2017

(54) VACUUMED GAP MEMBRANE DISTILLATION (VAGMED) MODULE, MULTI-STAGE VAGMED SYSTEMS, AND VAGMED PROCESSES

(71) Applicant: KING ABDULLAH UNIVERSITY OF SCIENCE AND TECHNOLOGY, Thuwal (SA)

(72) Inventors: Noreddine GHAFFOUR, Thuwal (SA); Ahmad ALSAADI, Thuwal (SA); Lijo FRANCIS, Thuwal (SA)

(21) Appl. No.: 15/538,286

(22) PCT Filed: Dec. 17, 2015
(86) PCT No.: PCT/IB2015/002518

§ 371 Date: Jun. 21, 2017

Related U.S. Application Data
(60) Provisional application No. 62/095,136, filed on Dec. 22, 2014.

(51) Int. Cl. B01D 61/36; C02F 1/44; B01D 63/02; B01D 63/08; C02F 103/08

(52) U.S. Cl. CPC B01D 61/364; B01D 61/368; B01D 63/02; B01D 63/08; C02F 1/447; B01D 61/366; B01D 2311/04; C02F 2103/08; C02F 2209/03; C02F 2301/063; B01D 2325/38

(57) ABSTRACT

Vacuumed gap membrane distillation (VAGMED) modules, and multi-stage VAGMED systems and processes using the modules are provided. In an embodiment, the membrane distillation modules can comprise: a) a condenser including a condensation surface; b) a first passageway having an inlet for receiving a first feed stream and an outlet through which the first stream can pass out of the first passageway, the first passageway configured to bring the first feed stream into thermal communication with the condensation surface; c) an evaporator including a permeable evaporation surface allowing condensable gas to pass there through; d) a second passageway having an inlet for receiving a second feed stream and an outlet through which the second feed stream can pass out of the second passageway, the second passageway configured to bring the second feed stream into communication with the permeable evaporation surface; and e) an enclosure providing a vacuum compartment within which the condenser, the evaporator and the first and second passageways of the module are contained.

### CROSS-REFERENCE TO RELATED APPLICATION

This application is the National Stage of International Application No. PCT/162015/002518, filed 17 Dec. 2015, which claims the benefit of and priority to U.S. Provisional Patent Application No. 62/095,136 entitled “VACUUMED GAP MEMBRANE DISTILLATION (VAGMED) MODULE, MULTI-STAGE VAGMED SYSTEMS, AND VAGMED PROCESSES”, filed on 22 Dec. 2014, all of which are expressly incorporated by reference as if fully set forth herein in their entirety.

### TECHNICAL FIELD

The present disclosure generally relates to membrane-based separation systems and processes, in particular membrane-based distillation systems and processes for desalination.

### BACKGROUND

Membrane distillation (MD) is a thermally driven membrane-based separation process, considered as one of the technologies that are emerging as alternative desalination processes. MD utilizes a hydrophobic, micro-porous membrane as a contactor to achieve separation by liquid-vapor equilibrium. Pre-heated feed solution is brought into contact with the membrane which allows only the water vapor to go through the membrane pores so that it condenses on the other side of the membrane. This vapor is driven across the membrane by the difference in the partial vapor pressure maintained at the two sides of the membrane created by the difference of temperatures (feed/coolant).

Conventional desalination technologies such as multi-stage flash distillation (MSF) and reverse osmosis (RO) are not only highly energy intensive processes but they require huge investment cost and large footprint (including extensive pretreatment required for the RO process); whereas MD operates at ambient pressure and lower temperatures (40-90° C.) so that any low grade heat source (solar, waste heat and low-enthalpy geothermal) can be sufficient for its operation. Moreover the scalability, low-cost polymeric materials for the installation, and the very high salt rejection reaching 99.95% (theoretically 100%) regardless of the feed concentration, makes MD as an attractive alternative desalination process.

The major configurations that have been employed in MD process are direct contact membrane distillation (DCMD), air gap membrane distillation (AGMD), vacuum membrane distillation (VMD) and sweeping gas membrane distillation (SGMD). In all configurations, hot feed solution is in direct contact with the membrane. In DCMD, both hot and cold streams are in direct contact with the membrane. In AGMD, a stagnant air gap is maintained between the membrane and a condensation surface (the coolant flows in the external side of the condensation surface). Distilled water could also be filled in the air gap, known as liquid gap MD configuration. In VMD and SGMD, vacuum and a cold inert gas are passed through the permeate side, respectively, so that the vapor coming across the membrane from the feed is condensed outside the membrane module.

Accordingly, there is a need to address the aforementioned deficiencies and inadequacies.

### SUMMARY

The present disclosure provides novel vacuumed gap membrane distillation (VAGMED) modules, multi-stage VAGMED systems, and VAGMED processes for different applications, such as water desalination, thermal and RO brines treatment, water reclamation and water reuse, and a membrane-based module for use in such systems. Current technologies such as MSF and RO are very high energy intensive and require high investment cost, large foot print, including extensive pretreatment for RO, and they are not environmentally friendly (emission of CO₂ and high chemicals consumption).

VAGMED operates at low temperature (40-90° C.) so that it is suitable for renewable energy, such as solar, low-enthalpy geothermal and any kind of low-grade waste heat such as from cooling towers, nuclear power stations. It operates at atmospheric pressure, which further reduces the operational cost. Also, the salinity of the feed water does not have much of an effect on VAGMED systems allowing operation at very high recoveries.

The novel design employed in the fabrication of the present VAGMED module ensures enhanced water production during the process. In addition, present device has advantages of being modular, having a lower footprint, being compact, having higher thermal efficiency through its more efficient heat recovery system, low investment cost (low-cost polymeric materials for the membrane and module fabrication), and having wide applications, such as water desalination, brines treatment, reclamation and reuse treatment units/plants.

In an embodiment, among others, a membrane distillation module is provided, comprising: a) a condenser including a condensation surface; b) a first passageway having an inlet for receiving a first feed stream and an outlet through which the first stream can pass out of the first passageway, the first passageway configured to bring the first feed stream into thermal communication with the condensation surface; c) an evaporator including a permeable evaporation surface allowing condensable gas to pass there through; d) a second passageway having an inlet for receiving a second feed stream and an outlet through which the second feed stream can pass out of the second passageway, the second passageway configured to bring the second feed stream into communication with the permeable evaporation surface; e) an enclosure providing a vacuum compartment within which the condenser, the evaporator and the first and second passageways of the module are contained; and f) a vacuum system coupled to the vacuum compartment of the enclosure. The vacuum system can be configured to control the pressure within the vacuum compartment of the module by adjusting the amount of vacuum applied to the vacuum compartment of the module relative to the saturation pressure of the second feed stream in the module and to remove uncondensed gas from the vacuum compartment.

In an embodiment among others, a multi-stage system is provided including a plurality of membrane distillation modules, each of the plurality of membrane distillation modules comprising the aforementioned membrane distillation module. The plurality of the membrane distillation modules can be coupled in series such that the outlet of the first passageway of one of the plurality of modules is coupled to the inlet of the first passageway of another of the plurality of modules and the inlet of the second passageway of the one of the plurality of modules is coupled to the outlet of the second passageway of the another of the plurality of modules, or vice versa. The system can include means for passing the first feed stream out of the outlet of the first passageway of the first module to the inlet of the first passageway of the another module; means for passing the first feed stream out of the outlet of the first passageway of the another module to the inlet of the second passageway of the another module wherein the first feed stream becomes the second feed stream to the another module; means for passing the second feed stream out of the outlet of the second passageway of the another module to the inlet of the second passageway of the first module, or vice versa. The vacuum system can be configured to control the pressure within the vacuum compartment of each module by adjusting the amount of vacuum applied to the vacuum compartment of each module relative to the saturation pressure of the second feed stream in each module and to remove non-condensable gas and uncondensed condensable gas (if any) from the vacuum compartment. Means for collecting condensate from each module can also be provided. In one or more aspects the second feed stream can incur a reduction in temperature due to evaporation of condensable gas from the second feed stream within the evaporator of each module of the plurality of membrane distillation modules. The number of modules of the plurality of membrane distillation modules can be determined based on including a module of the plurality of the membrane distillation modules for every 2-3° C. or more reduction in the temperature of the second feed stream in each of the modules. The first stream exiting the outlet of the first passageway of one of the modules can be heated to form the second feed stream and then delivered to the inlet of the second passageway of another one of the plurality of modules, or the second steam exiting the outlet of the second passageway of the another one of the plurality of modules is cooled to form the first stream and then delivered to the inlet of the first passageway of the one of the modules.

In an embodiment, among others, a method of membrane distillation is provided. The method can comprise the steps of: a) providing a module, the module including a condenser and an evaporator, the condenser of the module including a condensation surface, the evaporator of the module including a permeable evaporation surface allowing condensable gas to pass there through, a first passageway having an inlet for receiving a first feed stream and an outlet through which the first feed stream can pass out of the first passageway, the first passageway configured to bring the first feed stream into thermal communication with the condensation surface, and a second passageway having an inlet for receiving a second feed stream and an outlet through which the second feed stream can pass out of the second passageway, the module including an enclosure providing a vacuum compartment within which the condenser, the evaporator and the first and second passageways of the module are contained, wherein the vacuum compartment of the module is coupled to a vacuum system; b) providing a first feed stream to the inlet of the first passageway of the condenser of the module; c) cooling the condensation surface of the condenser of the module with the first feed stream; d) passing the first feed stream out of the outlet of the first passageway of the module; e) passing a second feed stream to the inlet of the second passageway of the module; f) evaporating condensable gas from the second feed stream and passing the condensable gas formed through the evaporation surface of the evaporator of the module; g) condensing the condensable gas on the condensation surface of the condenser within the module; h) passing the second feed stream out of the second passageway of the module; and i) using the vacuum system to control the pressure within the vacuum compartment of the module by adjusting the amount of vacuum applied to the vacuum compartment of the module relative to the saturation pressure of the second feed stream in the second passageway of the module.

In one or more aspects of the method, a plurality of membrane distillation modules can be provided. Each of the plurality of membrane distillation modules can comprise the aforesaid module. The plurality of modules can be coupled in series such that the outlet of the first passageway of one of the plurality of modules is coupled to the inlet of the first passageway of another of the plurality of modules and the inlet of the second passageway of the one of the plurality of modules is coupled to the outlet of the second passageway of the another of the plurality of modules, or vice versa. The method can include passing the first feed stream out of the outlet of the first passageway of the first module to the inlet of the first passageway of the another module; cooling the condensation surface of the condenser of the another module with the first feed stream; passing the first feed stream out of the first passageway of the another module; passing the second feed stream to the inlet of the second passageway of the another module, or vice versa. The method can include evaporating condensable gas from the second feed stream and passing the condensable gas formed in the another module through the evaporation surface of the evaporator of the another module; condensing the condensable gas on the condensation surface of the condenser within the another module, and passing the second feed stream out of the second passageway of the another module to the inlet of the second passageway of the first module. The second feed stream can incur a reduction in temperature due to evaporation of condensable gas from the second feed stream within the evaporator of each said module of the plurality of membrane distillation modules. The number of modules of the plurality of membrane distillation modules can be determined based on including a module of the plurality of membrane distillation modules for every 2-3° C. or more reduction in the temperature of the second feed stream in each of the membrane distillation modules. The first feed stream, after exiting the outlet of the first passageway of one of the modules, can be heated to form the second feed stream and then delivered to the inlet of the second passageway of another one of the plurality of modules, or the second steam, after exiting the outlet of the second passageway of the another one of the plurality of modules, is cooled to form the first stream and then delivered to the inlet of the first passageway of the one of the modules.

In any one or more aspects of the various embodiments, the first feed stream can be selected from the group consisting of seawater, brine solution, industrial waste water, produced water, brackish water and non-potable water and the condensable gas is water vapor. The first feed stream or the second stream, or both, can be de-gasified to remove non-condensable gas from the first feed stream or the second feed stream, or both, prior to being delivered to the module. The first feed stream can include a salt, a mixture of a salt and an organic contaminant or a mixture of a salt and an inorganic contaminant. The first feed stream can be a cold feed stream relative to temperature of the second feed stream, or the first feed stream can be cooled to have a colder temperature relative to the temperature of the second feed stream prior to being delivered to the inlet of the hollow body of the condenser of the module. The first feed stream, after exiting the first passageway of the module, can be heated to form the second feed stream and then delivered to the inlet of the second passageway of the module. The second feed stream can be a hot feed stream relative to the temperature of the first feed stream, or the second feed stream can be heated to have a hotter temperature relative to the temperature of the first feed stream prior to being delivered to the inlet of the second passageway of the module. The second feed stream after exiting the module can be cooled to form the first feed stream and then delivered to the inlet of the first passageway of the module. The second feed stream can include a salt, a mixture of a salt and an organic contaminant or a mixture of a salt and an inorganic contaminant. The permeable evaporation surface of the module can be selected from the group consisting of micro-porous hydrophobic membranes, nanocomposite membranes, surface modified membranes, dual layer composite hydrophobic/hydrophilic membranes, and modified ceramic membranes. The vacuum system can be used to control the pressure within the vacuum compartment of the module to be about 1% to about 5% below the saturation pressure of the second feed stream passed to the inlet of the hollow body of the evaporator of the module.

In any one or more aspects of the various embodiments, the condensation surface and the permeable evaporation surface can be configured in an opposed, spaced apart relationship forming an air gap there between within which condensable gas can be received. The condensation surface, the permeable evaporation surface, or both can be configured as a flat sheet. The condensation surface, the permeable evaporation surface, or both can be configured as a sheet having a non-flat configuration. Thus, for example, one of the condensation surface(s) or the permeable evaporation surface(s) can be a flat sheet while the other has a non-flat configuration. The non-flat configuration can be a sheet having a zigzag, sinusoidal, etc. or a hollow tube configuration. The condensation surface(s) and the permeable evaporation surface(s) can be hollow/hollow, flat/hollow, hollow/fat, flat/flat etc. The ratio of condensation surface area to permeable evaporation surface area can be 1:1, or more than or less than 1:1. The flow of the first and second streams can be from the inlet and out through the outlet of the first and second passage ways or in reverse flow.

Other devices, systems, processes, features, and advantages of the present disclosure for vacuumed gap membrane distillation (VAGMED) will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A and 1B depict a schematic diagram of an exemplary membrane-based separation module for use in a multi-stage vacuumed gap membrane distillation VAGMED system of the present disclosure, A) as a flat sheet and B) as a hollow fiber. Evaporation and condensation are done inside the same module.

FIG. 2 depicts staging the MD process to maintain heated feed at the water-vapor saturation curve.

FIGS. 3A-3C depict various process flow diagrams of the present disclosure for: A) a flat sheet VAGMED process using the module of FIG. 1A; B) a hollow fiber once through VAGMED module, wherein (the broken line represents a simple brine recycle VAGMED mode; and C) a hollow fiber complete brine recycle VAGMED process, the systems of FIGS. 3B and 3C using the module of FIG. 1B.

FIG. 4A depicts one way of a number of possible ways of fabricating a hollow fiber MD module of FIG. 1B, and FIG. 4B depicts a picture of a prototype unit of a hollow fiber MD module.

FIGS. 5A-5D depict various embodiments of a module of FIG. 1B.

FIGS. 6A-6E depict various additional embodiments of exemplary mixed evaporation and condensation hollow fibers module of the present disclosure. FIGS. 6F-H depict pictures of a prototype of a hollow fiber unit for use in a module.

FIG. 7 depicts an embodiment of a mixed flat sheet evaporation and condensation hollow fibers module.

FIG. 8 depicts simulated results of an VAGMED process including a staging flow diagram.

FIG. 9 depicts an example of a VAGMED reversal process design having multi-stage modules of treating hot feed sources as opposed to cold feed sources.

### DETAILED DESCRIPTION

Described below are various embodiments of the present devices, systems and methods for vacuumed gap membrane distillation. Although particular embodiments are described, those embodiments are mere exemplary implementations of the system and method. One skilled in the art will recognize other embodiments are possible. All such embodiments are intended to fall within the scope of this disclosure. Moreover, all references cited herein are intended to be and are hereby incorporated by reference into this disclosure as if fully set forth herein. While the disclosure will now be described in reference to the above drawings, there is no intent to limit it to the embodiment or embodiments disclosed herein. On the contrary, the intent is to cover all alternatives, modifications and equivalents included within the spirit and scope of the disclosure.

The present disclosure provides novel modules, systems and methods for vacuumed gap membrane distillation (VAGMED). In various aspects a module is provided for use in a vacuumed gap membrane distillation system. In various other aspects multi-stage vacuumed gap membrane distillation systems employing a plurality of the modules are provided comprising a plurality of the modules. In various other aspects vacuumed gap membrane distillation processes are provided.

The present VAGMED modules and processes can incorporate a thermal membrane-based process. The present systems and processes can include one or more of the membrane-based modules. The present systems and processes can be multi-stage systems and processes that include one or more of the membrane-based modules that, for example can be installed in series. Each module can represent a single stage, or one stage of a plurality of stages or effects.

In any one or more aspects the module can include:
1. A condensation surface. The condensation surface can be a thin polymeric or metallic plate or tubes (polymeric may be preferred to avoid corrosion of metal tubes). The condensation surface can be part of a heat exchanger that can be cooled by a cold feed stream. The cold feed stream can come from a feed source, or from a previous module, to recover the latent heat of condensation from vapor generated by the evaporation surface.
2. An evaporation surface. The evaporation surface can be a porous membrane. For example it can be a micro-porous, hydrophobic membrane that can be in a form of flat sheet or a hollow fiber. The membrane can be made of polymeric materials such as polypropylene, polyvinylidine fluoride, polytetrafluoroethylene, polyethylene, polyazoles etc. The membrane can receive a relatively hot feed stream as compared to the cold feed stream. The relatively hot feed stream can be from a heated stream source or from a previous module, for example in a counter-current flow regime with the cold feed stream that passes through the condensation surface. The relatively hot feed stream loses some of its mass and temperature through evaporation before it reaches the next module.
3. A vacuum compartment. The vacuum compartment or enclosure can be an airtight enclosure. The enclosure can be made of PVC or any other material that isolates the condensation and evaporation surfaces from the environment. The vacuum compartment can be connected to the next or a previous module or both via ports. In one or more aspects the vacuum compartment can have inlet and outlet ports for condensate transfer and inlet and outlet ports for connection to a vacuum system and applying vacuum. In various aspects the applied vacuum can be used to remove uncondensed gases present in the gap between the evaporators and condensers in the vacuum compartment. Raw feed water is de-aerated before it enters the system.

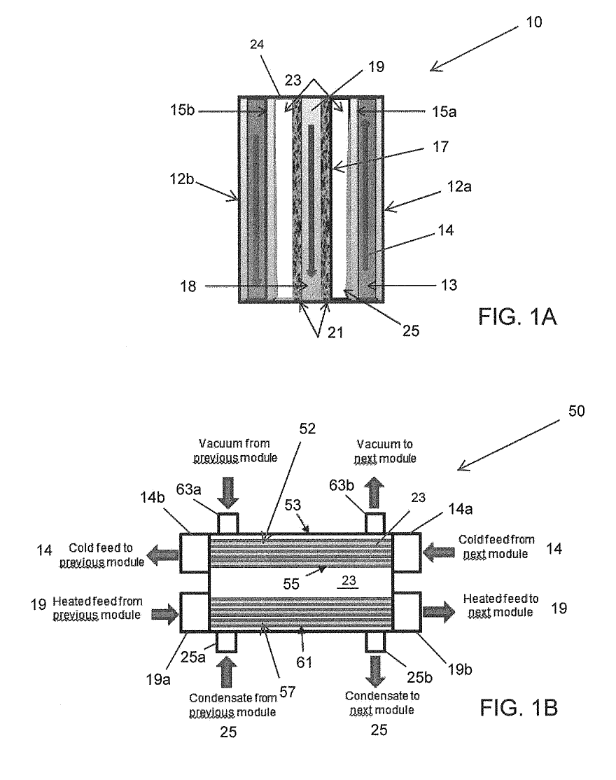

Schematic drawings of various aspects of a module of the present disclosure are presented in FIGS. 1A and 1B. FIG. 1A is a cross-sectional schematic view of an embodiment, among many, of a membrane-based separation module for use in the present system and method. The module 10 is a flat sheet module design. The module 10 of FIG. 1A includes one or more condensers 12 and evaporators 17. The one or more condensers 12 can be one or more heat exchangers and can include a passageway or conduit 13 allowing for a first feed stream 14, for example a cooling fluid, to pass through the condenser 12. The cooling fluid can be a cold feed stream 14. The cold feed stream 14 can be seawater, brine solution, industrial waste water, produced water, brackish water and/or non-potable water to be reused. The condenser 12 can include a condensation surface 15. The condensation surface may be made of a metal, though other materials that allow efficient thermal conductivity for the cooling of the condensation surface 15 by the cold feed stream 13. In various aspects a non-corrosive material may be preferred for the condensation surface, such as polymeric materials that have good thermal conductivity.

The evaporator 17 also includes a passageway or conduit 18 for allowing a feed stream 19, sometimes referred to as a second feed stream, to pass there through. The second feed stream can be a heated feed stream 19 or hot stream, e.g. natural geothermal spring or a discharge having high temperature which is enough to drive the process (direct multi-stage process) without a heat input. The heated feed stream can be a cold feed stream that has been heated. The evaporator 17 also includes an evaporation surface 21 on the exterior of the evaporator. The evaporation surface 21 can be designed or configured to allow condensable gas, for example water vapor, to pass out of the passageway 18 there through to the outside of the evaporator. In various aspects, the evaporation surface can be a porous membrane that allows water vapor to pass from the conduit 18 through the membrane and out of the evaporator 17. Suitable porous membranes can include micro-porous, hydrophobic membranes, nanocomposite membranes, surface modified membranes, dual layer composite hydrophobic/hydrophilic membranes, modified ceramic membranes, and any other membrane, coated or not, that permits that passage of water vapor. Exemplary micro-porous, hydrophobic membranes include nanofibrous membranes fabricated using electrospinning methodology, hollow fiber and flat sheet membranes fabricated using phase inversion methodology, and membrane surface modification using chemical vapor deposition (CVD), chemical treatment and plasma treatment methodologies.

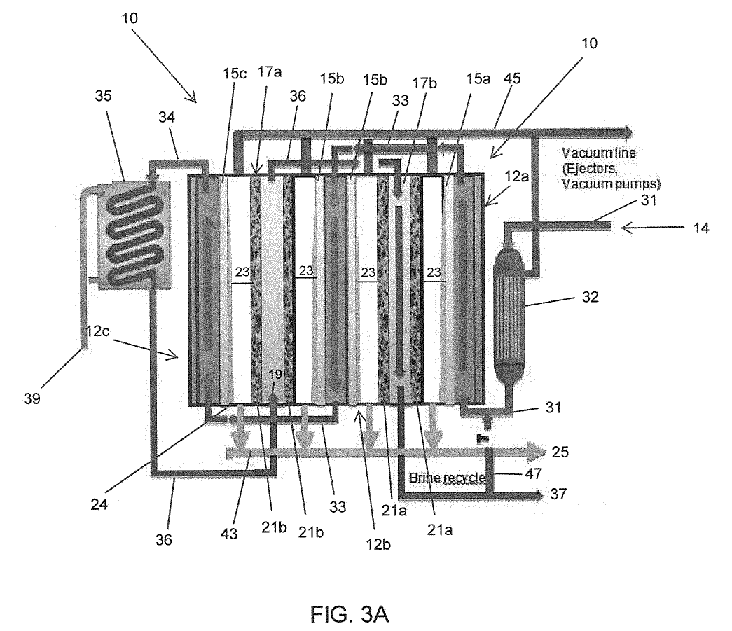

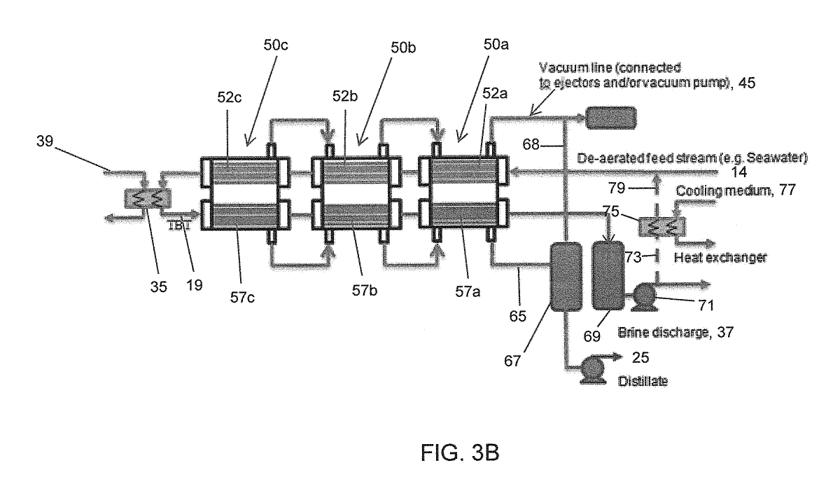

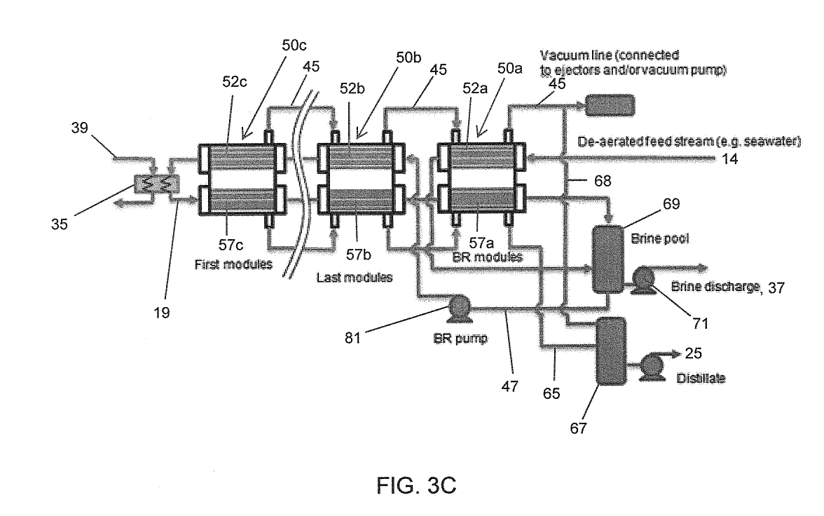

In the embodiment of FIG. 1A the condensation surfaces 15 and the evaporation surfaces 21 are generally flat sheets. As a non-limiting example, the ratio of evaporation to condensation surfaces areas can be adjusted to 1:1 (FIGS. 1A and 3A). But it can also have a higher condensation surface area to the evaporation one by using different condensation surface geometries, such as sinusoidal, zigzag, etc. The one or more condensers 12 can be positioned generally parallel or planar to the evaporators 17 and further spaced apart from evaporator 17 to provide one or more air gaps 23 between the condensation surface 15 of the one or more condensers 12 and the evaporation surface 21 of the evaporator 17. The one or more gaps 23 are configured to allow condensate, such as water condensation or distillate, to form in the one or more gaps 23 as result of the condensate that has passed through the evaporation surface 21 coming into contact with the cooler condensation surface(s) 15 of the condensers 12 and condensing in the air gaps 23.

The one or more condensers 12, evaporator 17 and air gap(s) 23 can be contained within a compartment or housing 24. Evaporation and condensation can then take place inside the housing 24 of the module. The evaporation can produce condensable gases, such as water vapor, from the heated feed stream 19. The heated feed stream 19 may also include non-condensable gases (for example, N₂, O₂, CO₂ and the like). Both condensable and non-condensable gases can pass through the evaporation surface 21. Vacuum can be applied to the housing 24 and thereby to the air gaps 23 to help promote transfer of the condensable and non-condensable gases through the evaporation surface 21, condensation of the condensable gases (e.g., water vapor) in the air gaps 23 within housing 24 and withdrawal of non-condensable gases, including excess uncondensed condensable gases, such as water vapor, from the air gaps 23. In various aspects, due to controlled vacuum applied to the housing the spacing of the air gaps 23 or width between the condenser(s) 12 and evaporator(s) 17 may not be important.

As depicted in FIG. 1A, the module 10 includes two condensers 12a, 12b having condensation surfaces 15a and 15b, respectively. A cold feed stream 14 enters the bottom of condenser 12a passing through passageway 13 of condenser 12a and exiting the top of the condenser to be cycled to enter the top condenser 12b passing there through and exiting the bottom of the second condenser 12b. The heated feed stream 19 can enter the top of evaporator 17 passing there through and exiting the bottom of the evaporator. The module, thus, provides counter-flow of the heated feed stream 19 in relation to the cold feed stream 14. One skilled in the art will recognize, however, that the various flows depicted in FIG. 1A can be reversed in any combination.

A non-limiting schematic drawing of various aspects of a multi-stage vacuumed gap membrane distillation system employing the module of FIG. 1A is depicted in FIG. 3A. In FIG. 3A a plurality of heat exchangers or condensers 12a, 12b and 12c are provided within one or more housings 24. Two evaporators, 17a and 17b, are alternatively positioned between the condensers. One skilled in the art, will recognize, however, that additional condensers and evaporators can be provided in a similar alternating fashion. The system can further include a conduit 31 for providing a cold feed stream 14 to the system. The conduit 31 can include a de-gasifier or de-aerator 32 to remove air and other non-condensable gases out of the cold feed stream 14 to improve the efficiency of the system. A portion of the conduit 31 connects de-aerator 32 to a first one of the condensers 12a for providing the cold feed stream 14, for example seawater, from the de-aerator 32 to the passageway 13a of condenser 12a. Additional conduits 33 can be provided to transport the cold feed stream 14 from one condenser to the next condenser in a series of condensers. For example a conduit 33 can provide the cold feed stream 14 from condenser 12a to the passageway 12b of the next condenser, in this case condenser 12b. Similarly a conduit 33 is provided for transporting the cold feed stream 14 exiting the second condenser 12b for entry into the passageway 13c of a third condenser 12c and so on.

The cold feed stream 14 exiting condenser 12c can then be provided by way of an additional conduit 34 to a heat exchanger 35 for heating the stream. Conduits 36 then deliver the heated stream 19 for passing through a first evaporator 17a, exiting evaporator 17a and delivering the heated stream 19 to a second evaporator 17b, passing out of evaporator 17b to a discharge 37. Any type of heat source 39 can be applied to the heat exchanger 35 for heating the stream.

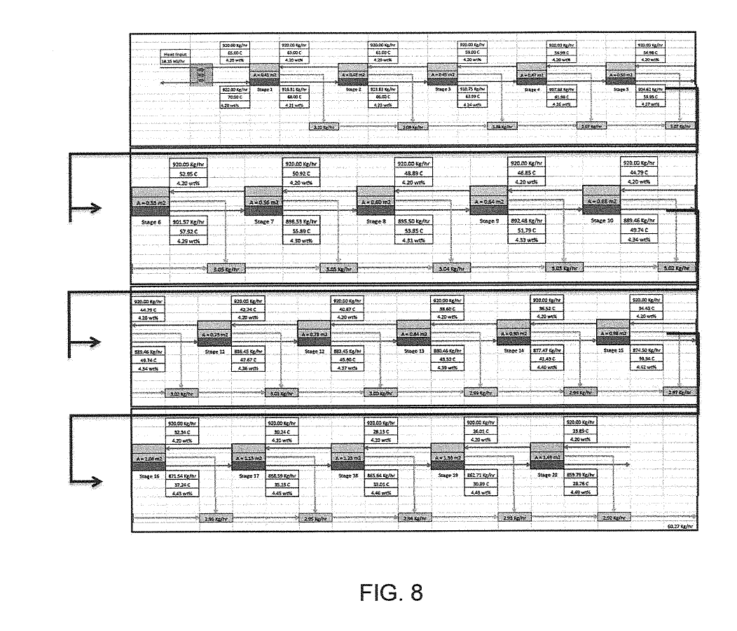

Since the system runs under constant, or almost, temperature difference between evaporation and condensation in all stages, the same value of the temperature difference can be provided by the external heat source (typically low increase of 3-10° C.). Suitable heat sources include solar thermal collectors, low-enthalpy geothermal energy, low-grade waste heat from industrial plants, low-grade steam from nuclear power plants, or waste heat from diesel engines. If raw feed water is hot enough to drive the process without the need for external heat source, the process can be reversed. We call it direct multi-stage vacuumed gap membrane distillation unit (FIG. 8) where a cooling medium is required instead of a heat source (see VAGMED Reversal Section below).

As can be seen the system of FIG. 3A thus provides counter-flow of the cold feed stream 14 through the condensers 12 in relation to the flow of the heated feed stream 19 through the evaporators 17. The cold feed stream 14 can enter the system at a relatively cold temperature. In various aspects the temperature of the cold feed stream 14 can be an ambient temperature of about 20° C. to about 30° C., or more or less. In various aspects the cold feed stream 14 can be seawater, or other liquid including a concentration of salt or any other composition, e.g. industrial wastewater). The cold feed stream 14 can be heated to incrementally higher temperatures as it passes through the series of condensers 12 ultimately to the heat exchanger 35. For example, the cold feed stream 14 can be successively heated as it passes through the series of condensers 12 by the release of latent heat in each condenser due to the condensation of water vapor on the condensation surfaces 15.

The heat exchanger serves to heat the feed stream to provide a heated feed stream 19 to be delivered to the evaporators 17 and to promote production of water vapor. In one or more aspects the heat exchanger may heat the feed stream to the top brine temperature (TBT) of the stream. The heated feed stream 19 enters each of the evaporators 17 in series where water vapor from the heated feed stream 19 passes through the evaporation surfaces 21 of each successive evaporator into the air gaps 23 where the water vapor condenses on the colder condensation surfaces 15 of the condensers 12. Due to the loss of water vapor from the series of evaporators 17 the heated feed stream 19 can be successively cooled as it passes from heat exchanger 35 through the various modules or stages to brine discharge 37.

The system can be provided with a plurality of conduits 43 to collect the condensate or distillate 25 from the air gaps and remove it from the system. One or more vacuum lines 45 can be connected to the air gaps 23 to place the air gaps under vacuum and to remove uncondensed or excess water vapor from the vacuum compartment(s). The distillate collected will be relatively salt-free, the water vapor leaving behind the salt or brine in the heated feed stream 19. The concentrated brine can be removed from the final evaporator 17b by way of the brine discharge 37. Additionally, if desired a recycle loop 47 can be provided to recycle brine solution back to the conduit 31 connecting the de-aerator 32 to a first condenser 12a.

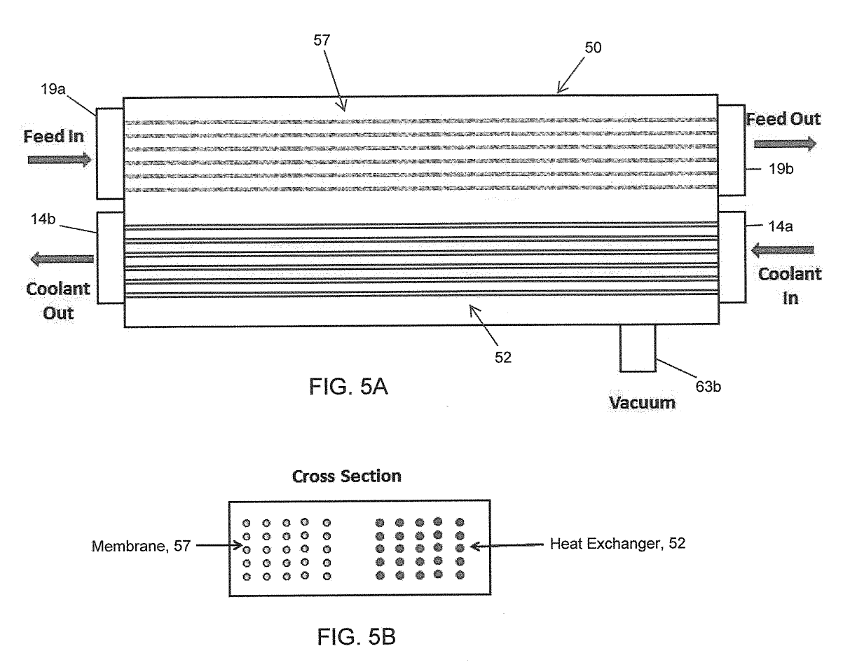

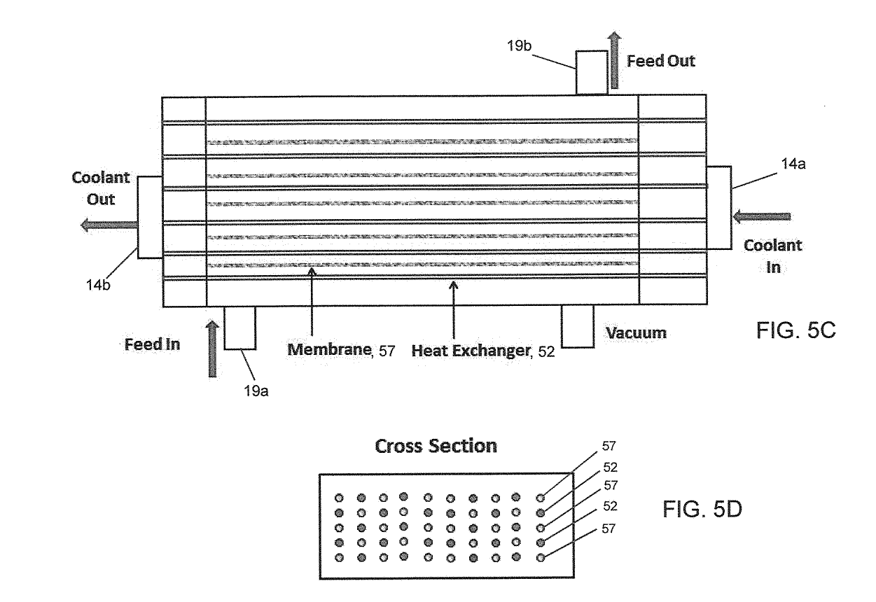

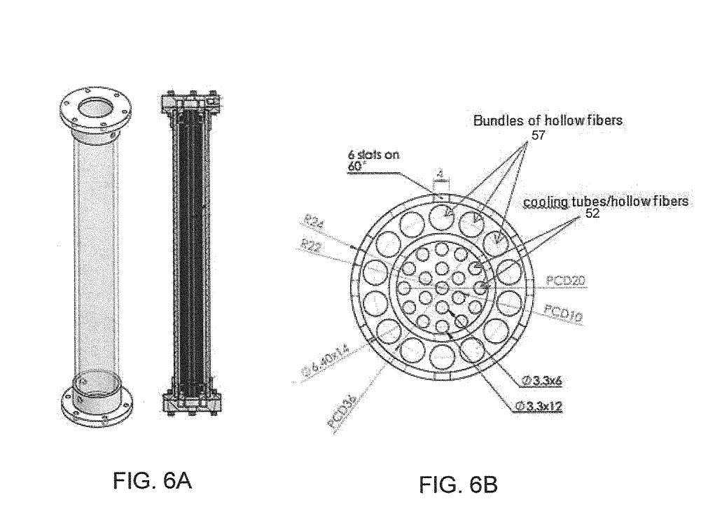

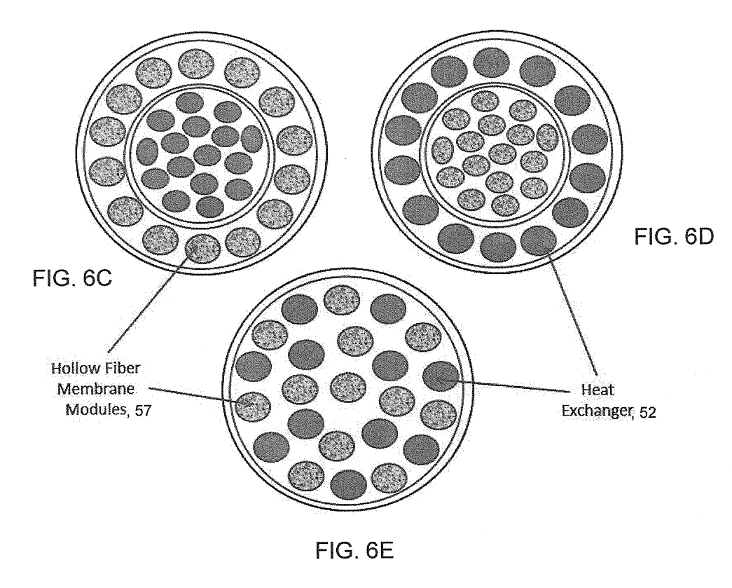

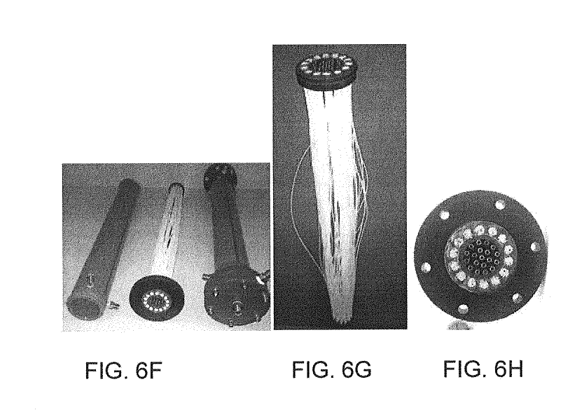

Depicted in FIG. 1B is another embodiment of a membrane-based separation module for use in the present systems and methods. The module 50 of FIG. 1B operates on a principle similar to that of the module 10 of FIG. 1A. Module 50 includes a condenser 52 and an evaporator 57. Each can be comprised of one or more sections or tubes. As depicted in FIG. 1B each includes three sections or tubes installed within the same module enclosure 53 under vacuum. Either or both the condenser 52 and the evaporator 57 can be comprised of more tubes or fewer tubes with different arrangements, such as depicted in FIG. 5 and FIG. 6 discussed in more detail below. Condenser 52 includes one or more condensation surfaces 55. Evaporator 57 includes one or more evaporation surfaces or membranes 61. The various sections or tubes of the condenser 52 and the evaporator 57 are configured or positioned to provide air gaps 23 there between. As with the embodiment of FIG. 1A, the spacing of the air gaps 23 or width between the condenser 52 and the evaporator 57 may not be important with the application of controlled vacuum.

The module 50 can be configured to provide an enclosure 53 about the condenser 52 and evaporator 57 and the air gaps sealing the condenser 52 evaporator 57 and air gaps 23 from the environment and allowing vacuum to be applied to the gaps or spaces 23 within the module 50. Thus, evaporation and condensation take place within the enclosure 53 of the module. Module 50 can further include a cold feed stream inlet port 14a and a cold feed stream outlet port 14b for delivering a feed stream 14 to the condenser 52, allowing the cold feed stream 14 to pass through the condenser 52 and ultimately to exit the module. This hollow fiber module design (FIG. 1B) can have a ratio of condensation to evaporation surfaces of 1:1 (FIG. 1A), but also can have a higher condensation surface to the evaporation one or vice versa by increasing the number of fibers (evaporation or condensation as required). In addition, a mixture of flat sheet and hollow fiber can be used for evaporation and condensation, respectively, and vice versa, with different evaporation to condensation surface area ratios.

Similarly, the module 50 can include an inlet port 19a for receiving a heated feed stream 19 for delivery to evaporator 57 and an outlet port 19b for removing the heated feed stream from the evaporator 57 and the module. The module 50 can include an inlet and outlet ports 25a, b for receiving condensate or distillate 25 from another module and for removing condensate from module 50, respectively, as well as inlet and outlet ports 63a, b for the vacuum system. While one inlet and one outlet of each of the various ports are depicted, one skilled in the art will understand that more than one of each of the ports can be provided.

Module 50 operates in a similar manner to module 10 in that the heated feed stream 19 is heated to promote production of condensable gases (e.g., water vapor) which can along with non-condensable gases pass through evaporation surface(s) 61 into the air gaps 23 where the condensable gases can condense on the surface(s) 55 of condenser 52 within the enclosure 53. The condensate 25 can be removed from module 50 by way of the condensate outlet port 25b. Excess water vapor and other non-condensable gases that do not condense within module 50 can be removed through the vacuum outlet port 63b by way of a vacuum system 45.

Depicted in FIGS. 3B and 3C are various embodiments of multi-stage applications of the module 50 of FIG. 1B. Three modules 60a, b, c are depicted in series for receiving a cold feed stream, for example, seawater. As in FIG. 3A the cold feed stream 14 can first be passed through a de-gasifier or de-aerator 32 to remove air and other gases from the stream. The cold feed stream 14 is then delivered to the cold stream inlet port 14a of a first module 50a. Each of the modules includes a heat exchanger or condenser 52 and an evaporator 57 such as described in relation to FIG. 1B. While the system is depicted as including three modules 50a, b, c in series the system can include 1, 2, 3, or more modules. The cold feed stream 14 enters the condenser 52a of module 50a passing there through to be delivered to condenser 52b of module 50b and from there on to condenser 52c of module 50c where the cold feed stream 14 exits the last module and is delivered to heat exchanger 35. The cold feed stream 14 can be successively heated as it passes through the series of condensers 52 by the release of latent heat in each condenser due to the condensation of water vapor on the condensation surfaces 55.

The heat exchanger 35 can be similar to that discussed above in relation to FIG. 3A. The heat exchanger 35 heats the stream to provide a heated feed stream 19 and to promote production of condensable gases (e.g., water vapor). The heated feed stream 19 is delivered to evaporator 57c of module 50c, from thereon to evaporator 57b of module 50b and onto evaporator 57a of module 50a. Water vapor exits evaporators 57a, b, c through their respective evaporation surfaces 61 into the respective air gaps 23 of each of the modules where the water vapor condenses on the condensation surfaces 55 of the respective condensers 52. Due to the loss of condensable gases from the series of evaporators 57 the heated feed stream 19 can be successively cooled as it passes from heat exchanger 35 through the modules to brine discharge 37.

Condensate from module 50c can be passed out of the condensate outlet port onto module 50b. Condensate from module 50b can be passed onto the condensate inlet port of module 50a. Ultimately condensate 25 from the first module 50a can be collected and delivered by way of a conduit 65 to a storage tank 67.

As an example, the heated feed stream 19 can exit the evaporator 57a of module 50a as concentrated brine solution 37 and can be delivered to brine storage tank 69. Ultimately the concentrated brine discharge 37 may be distributed further, as desired, by pump 71. Optionally a portion of the brine discharge 37 may be cycled or recirculated by conduit 73 back to be incorporated with the cold feed stream 14 optionally passing through a heat exchanger 75 where it may be cooled by a cooling medium 77 and then delivered by conduit 79 to join the cold feed stream 14 for delivery to the condenser 52a of module 50a.

A vacuum system 45 can be configured to include a vacuum outlet port in module 50c where vacuum is drawn and delivered to vacuum inlet port of module 50b which has a vacuum outlet port delivering vacuum to the vacuum inlet port of module 50a. Ultimately excess, uncondensed gases, for example uncondensed condensable gases (e.g., water vapor) and non-condensable gases, can be collected out of module 60a by the vacuum system 45. Some of the excess condensable gases may condense in the vacuum system which condensate may be delivered by conduit 68 to the condensate storage tank 67. Thus, similar to the system of FIG. 3A, the system of FIG. 3B incorporates a plurality of modules 50 and can provide counter-current flow of a cold feed stream 14 in relation to a heated feed stream 19 to promote production of condensable gases and condensation of the gases to collect condensate or distillate 25. Where the condensable gases are water vapor the condensate can be water that is substantially free of salt or brine.

FIG. 3C depicts a further version of the system of FIG. 3B employing a plurality of the modules 50 depicted in FIG. 1B. As depicted in FIG. 3C the system can include any number of modules beyond the three illustrated. The system of FIG. 3C operates in a similar manner to that of FIG. 3B, having however an additional loop. In an aspect where the feed stream 14 is a form of salt water, the additional loop can be a brine recycle loop. Instead of delivering the cold feed stream 14 exiting the condenser 52a of the first module 50a directly to the condenser 52b of module 50b, the cold feed stream 14 can be diverted to a brine collection tank 69 (brine pool) and a portion of brine solution in the brine collection tank 69 can be delivered as the cold feed stream 14 to condenser 52b of module 50b. A pump 81 (that may be a brine recycle pump) may be provided to assist in delivering brine solution as a cold feed stream 14 to the second module 50b. In this depicted embodiment, module 50b can be the last module in the series of multi-stage membrane distillation modules and module 50a can be a brine recycle module that is part of the brine recycle loop. One or more modules can be staged in series with module 50a as part of the brine recycle loop.

The cold feed 14 of the VAGMED modules, systems and processes can be raw seawater, thermal or membrane desalination brines, produced water, wastewater, groundwater or surface water. Referring to the multi-stage systems, for example depicted in FIGS. 3A-3C, the cold feed stream 14 can enter the first module as a coolant for the condensation surface(s) 15, 55 to recover the latent heat of condensation from the vapor that condenses on the condensation surface(s) of that module and then flows to the next module (before last) to recover more energy in a similar manner and so on. The number of modules can be determined through specific designs depending on the plant size and the operating parameters. The operating parameters can include cold feed stream inlet temperatures, heated feed stream temperatures, flow rates, module length, and hydrophobic membranes specification.

The cold feed stream 14 exits the first module where its temperature can be increased to reach the top brine temperature (TBT) using a heat source 39 for heat exchanger 35. In this case the “first module” is the module in the series closest to heat exchanger 35. In the embodiments depicted in FIGS. 3B and 3C the first module is module 50c. The heat source 39 can be solar thermal panels, low-enthalpy geothermal energy, low-grade waste heat, low-grade steam or electrical heat supply. The feed stream can then pass through heat exchanger 35 before it enters an evaporator 17, 57 having an evaporation surface 21, 61. The evaporation surface can be a channel made of a micro-porous hydrophobic membrane of the first module to receive the heated feed stream 19 from the heat exchanger 35 (FIGS. 3A-3C). The temperature difference created by the heating source as well as the vacuum applied to the module compartment or enclosures 23, 53 cause part of the heated feed steam 19 to evaporate forming water vapor. The driving force for the evaporation can be created by a pressure difference between the two sides of the membrane of the evaporation surface. The water vapor can pass through the membrane pores to the condensation surface 15, 55 of the condenser 12, 52. Condensation can take place in the air gap 23 between the hydrophobic membrane surface and the condensation surface within the housing 24 or enclosure 53.

The air gap can be a small air gap. In various aspects the air gap can be up about 200 mm. In other aspects the air gap can be as small as about 1 mm, 2 mm or 5 mm. In yet other aspects the air gap can be more than 5 mm up to about 200 mm, under the condition of efficient vacuum system (efficient non-condensable gases removal).

After losing some mass due to evaporation that also leads to a drop in its temperature, the heated feed steam 19 enters the evaporator of the next module where more water vapor can pass through its evaporation surface. The vacuum inside the next module enclosure can be adjusted to be slightly lower than the saturation pressure of the temperature of the heated feed stream 19 entering the next module to aid further in promotion and passing of water vapor through the evaporation surface. Setting or adjusting the pressure to be slightly lower than the saturation has the benefit in aiding the gases passing through the membrane of the evaporation surface 21, 61 to overcome membrane structure resistance. By slightly lower we mean 1-5% of the saturation pressure depending upon the temperature of the heated feed stream entering the next module. The heated feed stream 19 can continue in a similar manner until it exits the last module (for example, module 50a depicted in FIGS. 3B and 3C) as a concentrated feed stream where it is discharged as brine 35 (once-through VAGMED) or recycled back fully or partially to the process as feed to a condenser of an intermediate module (for example, as feed to condenser 52b of module 50b, as depicted in FIG. 3C), or after its temperature is lowered by a cooling medium 77 (brine recycled VAGMED) in heat exchanger 75, as depicted in FIG. 3B.

The maximum production of distillate 25 from the VAGMED system (theoretically the product is distilled water quality as pure vapor is condensed only if no membrane pore wetting occurs) depends on the temperature difference between the heated feed stream 19 that enters the first module and the temperature of the brine stream 65 exiting the process, as well as the heated feed stream 19 flow rate that enters the evaporation section of the system according to the following equation:

$${M}_{D} = \frac{{M}_{F} ( {T}_{F} - {T}_{B} )}{( \frac{{h}_{g}}{{C}_{p}} - {T}_{B} )} \qquad ( 1 )$$

where M_{D} and M_{F} are the mass flow rates of the distillate 25 and heated feed stream 19, respectively, T_{F} and T_{B} are the temperatures of the heated feed stream 19 that enters the first module and exits the last module, respectively, h_{g} and Cₚ are the average enthalpy of the generated water vapor and the average specific heat of the feed, respectively.

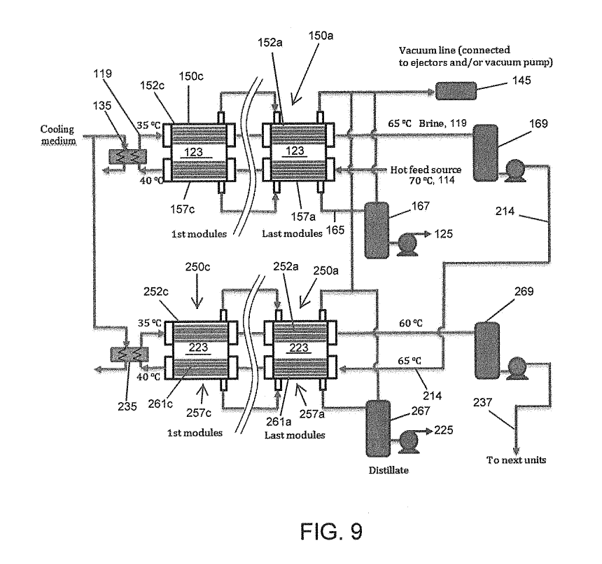

As mentioned above, if raw feed water is hot enough to drive the process without the need for external heat source, the process could be reversed. We call it direct multi-stage vacuumed gap membrane distillation process and device (FIG. 9) where a cooling medium is required instead of a heat source.

### The Removal of Non-Condensed Gases and VAGMED Staging

Reducing the module enclosure absolute pressure by applying a vacuum can increase the VAGMED condensable gas flux (such as water vapor flux), and help sustain evaporation and formation of condensable gas (such as water vapor), due to removal of the mass transfer resistance caused by the non-condensable gases that preoccupied the module enclosure. However, the more we reduce the enclosure pressure below the saturation pressure of the heated feed stream temperature, the lower the cooling temperature needed for condensing the condensable gas or water vapor. Therefore, in various aspects, from a practical point of view a preferred housing or enclosure pressure can be slightly below the saturation pressure of the heated feed stream 19 temperature to assure the complete removal of non-condensed gases and to sustain enough driving force for the condensable gas to overcome the hydrophobic micro-porous membrane structure mass transfer resistance. The non-condensed gases can be non-condensable gases, but they may also include uncondensed condensable gases. The preferred pressure also can be high enough to allow the condensable gas to condense on the condensation surface 15, 55. Therefore, in various aspects the pressure difference between the enclosure (vacuum compartment) pressure and the saturation pressure of the heated feed stream 19 can be between about 1% and about 5% of the saturation pressure depending upon the temperature of the heated feed stream entering the evaporator within the vacuum compartment of the module. In various aspects the temperatures of the condensation surfaces 15, 55 can be maintained slightly lower than the saturation temperature of the water vapor. For example, the temperature of the condensation surfaces 15, 55 can be about 3° C. to about 7° C. lower than the saturation temperature of the condensable gas.

As mentioned earlier, the heated feed stream 19 temperature decreases along the membrane channel of the first module due to the heat loss through evaporation. Such decrease in temperature creates a practical difficulty in maintaining the enclosure pressure at the saturation pressure of the feed temperature in a single module. A solution to this problem can be through a staging of the evaporation and condensation processes. When the heated feed stream 19 temperature decreases by 3° C., for example, in the first module due to evaporation, the system can be configured such that it flows into another module (next stage) where the pressure is lowered relative to the saturation pressure at that heat feed stream temperature and so on (for the next stages). Thus in various aspects, the amount of vacuum applied to the next module vacuum compartment is increased in order to affect the lower pressure. The vacuum system 45 can be configured to affect a different pressure within the vacuum compartment 24, 53 of each module in the multi-stage system. For example, the vacuum system 45 can be configured to effect a different pressure within the vacuum compartment 24, 53 of each successive module such that the first stage module, the module closest to heat exchanger 35, has the highest pressure and each module downstream from the first stage module has an increasingly lower pressure within its respective vacuum compartment.

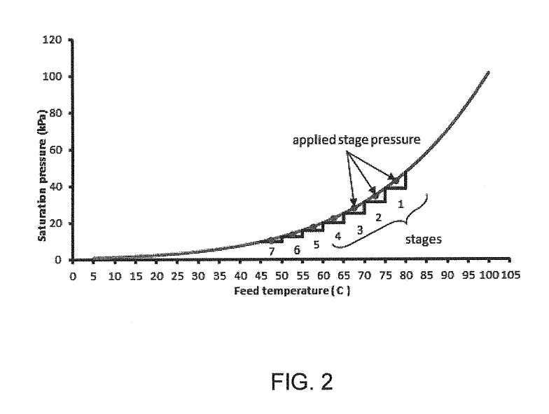

FIG. 2 shows that in order to maintain the pressure at the saturation pressure of the feed temperature, infinite stages are required. In FIG. 2 the temperature of the heated feed stream is shown along the x-axis. The stages are numbered such that stage no. 1 is the stage or module closest to heat exchanger 35, stage no. 2 is next module in the series of modules moving away from heat exchanger 35. FIG. 2 shows that each successive stage or module in the series of modules has a lower heated feed stream temperature and a correspondingly lower saturation pressure. The vacuum system 45 can be configured to adjust the amount of vacuum applied to each successive stage in order to lower the pressure (i.e., increase the amount of vacuum) within each successive vacuum compartment relative to the lower saturation pressure in each stage. As noted above, in various aspects the vacuum system can be configured to effect a pressure within each successive vacuum compartment that is about 1-5% below the successively lower saturation pressure in each stage.

However, since this is not practically possible, in one or more aspects we can use one module for every 2-3° C. reduction in heated feed stream 19 temperature (higher ΔT leads to lower number of stages but lower efficiency). In this way, the highest absolute pressure is applied at the first stage (closest to heat exchanger 35) while the lowest one is maintained at the last stage (farthest from heat exchanger 35). Since the enclosures of the modules are connected together, the vacuum system is preferably connected at the last modules (as depicted in FIGS. 3B and 3C) to minimize the loss of condensable gas or water vapor. To remove non-condensable gases a venting line can be installed in each stage. The vacuum in the other modules can be adjusted by pressure control devices according the partial pressure of the heated feed stream 19 entering each module. In addition, all raw cold feed water 14 can be de-aerated 32 to remove a large amount of non-condensable gases, such as O₂, CO₂ and N₂. One skilled in the art will recognize that the temperatures and flow rates of the cold feed stream 14 and the heated feed stream, the saturation pressure (which is related to the temperature of the heated feed stream), the pressure (amount of vacuum) within in the vacuum compartment, and the amount of evaporation and condensation surface within a stage all affect the design of the stages and the number of stages (modules) of the present multi-stage distillation system.

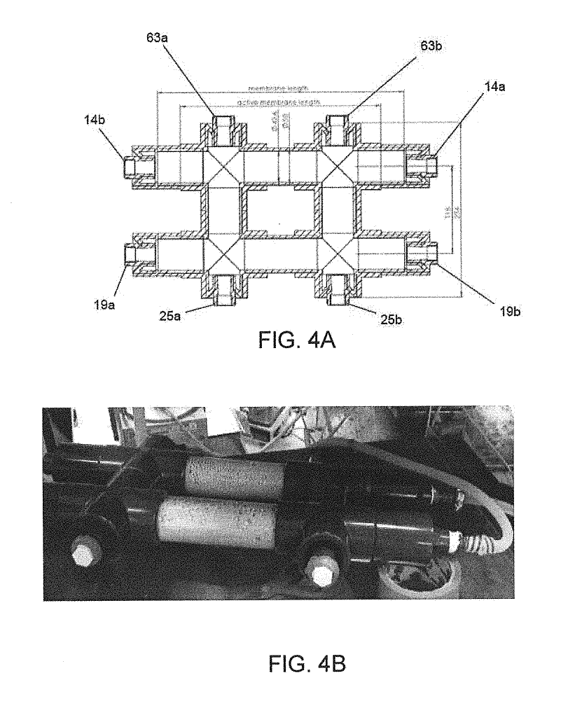

One possible way of fabricating a hollow fiber module MD compartment design is represented in FIGS. 4A and 4B (see FIG. 1B). Design specifications such as the gap width between evaporation and condensation and their respective surface areas, packing density, module length and diameter, and the number of stages can be set for each configuration and specific application through modeling/simulation software. The compartment design of FIGS. 4A and 4B can be fitted internally with a plurality of condensation and evaporation tubes, as depicted in FIG. 1B. Alternative embodiments for the fitting of the condensation and evaporation tubes are depicted in FIGS. 5A-5D.

Another hollow fiber module design is a mixed configuration of evaporation (MD membranes) and condensation (condensation tubes) inserted in one shell and tube configuration, as shown in FIGS. 6A-6H. Different configurations are possible, e.g. condensation tubes can be installed in the inner part and the MD hollow fibers (evaporation) in the outer part (FIGS. 6B and 6C). They can also be installed in the other way (hollow fiber membranes in the inner part, FIG. 6D) or completely mixed in one single bundle (FIG. 6E).

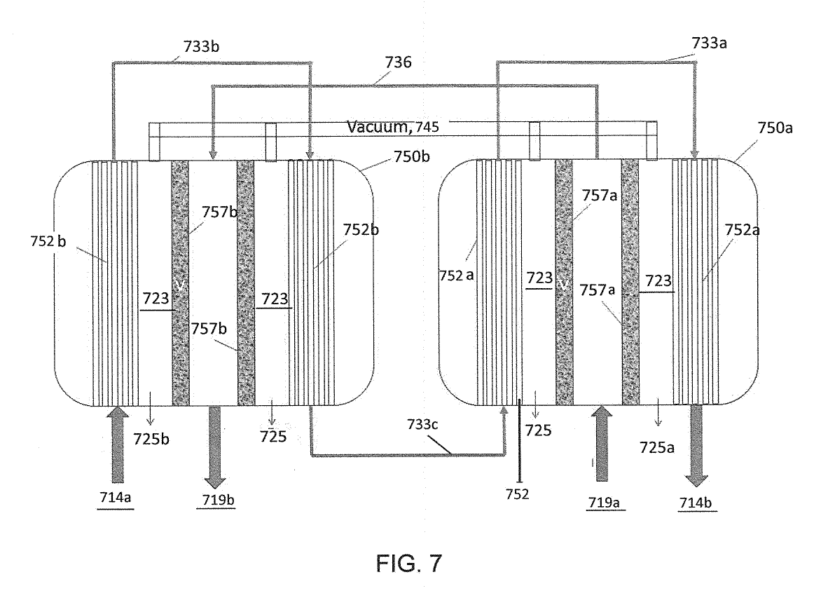

In yet another embodiment, the one or more modules of the present disclosure can have an evaporator configured with a sheet, either flat or non-flat, and a condenser configured with the above described hollow fiber configuration, or vice versa. FIG. 7 depicts one aspect of such an embodiment including two modules 750 a, b connected in series. Each module includes an evaporator 757a, b comprised of a pair of opposed flat sheet membranes that provide a passage therebetween for feed inlet 719A and feed outlet 719B. The feed passage ways of the two modules can be coupled by a conduit 736. Each module 750 a, b also includes condensers 752a, b comprised of a bundle of fibers such as condenser 53 of FIG. 1B. Coolant, as described herein, can be fed into the condensers 752a and 752b of modules 750a and b, respectively. Conduits 733a, 733b and 733c can be provided to couple the coolant passing out of and into the respective condensers. In the embodiment of FIG. 7, permeate passes through the flat sheet membranes 757a, b condensing in the airgaps or spaces 723 to be collected at the respective outlets 725a and 725b of the modules. One skilled in the art will recognize that the configuration of FIG. 7 can be reversed wherein the evaporators 757a and b can each be comprised of a bundle of hollow fibers as described herein and the condensers 752a, b can be comprised of a sheet membrane, flat or non-flat, to which coolant can be provided on one side of the sheet condenser to provide a condensing surface on the opposed side of the sheet condenser. Evaporation and condensation surfaces can be optimized for each case.

We have thus described a number of configurations wherein the condensation surface(s) and permeable evaporation surface(s) have a hollow tubular design or, as described earlier a flat design as in for example FIG. 1A. One skilled in the art will recognize that the condensation/evaporation surfaces can be hollow/hollow, flat/hollow, hollow/flat, flat/flat, etc.

As an example, simulated results of an VAGMED unit are presented in FIG. 8 and Table 1. Twenty modules or stages are simulated therein. The system, however, can have more or less stages. In this example, the temperature of the heated feed stream 19 from heat exchanger 35 entering stage 1 is 70° C. This temperature of the heated feed stream can be related to the top brine temperature (TBT) of the stream and can be higher or lower. For example it can be 75° C. or 80° C. or another temperature. The temperature of the cold feed stream entering the system (at stage 20), though its temperature can be higher or lower. Similarly the flow rates of the cold feed and heated feed streams can be higher or lower than simulated (see Table 1).

TABLE 1
Simulated Results of an VAGMED Process (Calculated Data)

| | | Feed | Feed | Feed | Feed in | | Coolant | coolant | | | |
|---|---|---|---|---|---|---|---|---|---|---|---|
| Stage | Feed in | out | in | out | salinity | Feed outlet | in | out | product | membrane | pressure |
| No. | kg/hr | kg/hr | temp C. | temp C. | wt % | salinity wt % | temp C. | temp C. | kg/hr | area [m²] | (pa) |
| 1 | 920.00 | 916.91 | 70.00 | 66.00 | 4.20 | 4.21 | 63.00 | 65.00 | 3.10 | 0.41 | 30412.38 |
| 2 | 916.91 | 913.83 | 66.00 | 66.00 | 4.21 | 4.23 | 61.00 | 63.00 | 3.09 | 0.43 | 27879.84 |
| 3 | 913.83 | 910.75 | 66.00 | 63.99 | 4.23 | 4.24 | 59.00 | 61.00 | 3.08 | 0.45 | 25521.00 |
| 4 | 910.75 | 907.68 | 63.99 | 61.98 | 4.24 | 4.25 | 56.99 | 58.99 | 3.07 | 0.47 | 23326.25 |
| 5 | 907.58 | 904.62 | 61.98 | 59.95 | 4.26 | 4.27 | 54.55 | 55.98 | 3.07 | 0.50 | 21265.67 |
| 6 | 904.62 | 901.57 | 59.95 | 57.92 | 4.27 | 4.29 | 52.95 | 54.95 | 3.05 | 0.53 | 19393.69 |
| 7 | 901.57 | 888.53 | 57.92 | 55.89 | 4.29 | 4.30 | 50.92 | 52.92 | 3.05 | 0.56 | 17641.79 |
| 8 | 898.53 | 895.50 | 55.89 | 53.65 | 4.30 | 4.31 | 48.89 | 50.89 | 3.04 | 0.60 | 16021.48 |
| 9 | 895.50 | 892.48 | 53.85 | 51.79 | 4.31 | 4.33 | 46.85 | 48.85 | 3.03 | 0.64 | 14525.21 |
| 10 | 892.48 | 889.46 | 51.79 | 49.74 | 4.33 | 4.34 | 44.79 | 46.79 | 3.02 | 0.66 | 13145.12 |
| 11 | 889.46 | 886.45 | 49.74 | 47.67 | 4.34 | 4.36 | 42.74 | 44.74 | 3.01 | 0.73 | 11874.47 |
| 12 | 886.45 | 883.45 | 47.67 | 45.60 | 4.36 | 4.37 | 40.67 | 42.67 | 3.00 | 0.78 | 10706.36 |
| 13 | 883.45 | 880.46 | 45.60 | 43.52 | 4.57 | 4.39 | 58.60 | 40.60 | 2.99 | 0.84 | 9635.50 |
| 14 | 880.46 | 877.47 | 43.52 | 41.43 | 4.39 | 4.40 | 55.52 | 55.52 | 2.99 | 0.90 | 8654.93 |
| 15 | 877.47 | 874.50 | 41.46 | 39.34 | 4.40 | 4.42 | 34.43 | 36.43 | 2.97 | 0.98 | 7756.26 |
| 16 | 874.50 | 871.54 | 39.34 | 37.24 | 4.42 | 4.43 | 32.34 | 34.34 | 2.96 | 1.05 | 6940.15 |
| 17 | 871.54 | 868.59 | 37.24 | 35.13 | 4.43 | 4.45 | 30.24 | 32.24 | 2.95 | 1.15 | 6195.69 |
| 18 | 868.59 | 865.64 | 35.13 | 33.01 | 4.45 | 4.46 | 28.13 | 30.13 | 2.94 | 1.25 | 5518.88 |
| 19 | 865.64 | 862.71 | 33.01 | 3.089 | 4.46 | 4.48 | 26.01 | 28.01 | 2.93 | 1.36 | 4905.07 |
| 20 | 862.71 | 859.79 | 3.059 | 28.76 | 4.48 | 4.49 | 28.89 | 28.89 | 2.92 | 1.49 | 4349.71 |
| | | | | | | | | Total | 60.27 | 15.79 | |

### VAGMED Reversal

One or more further embodiments are provided when the feed source input to the system is a hot feed source instead of a cold feed source and a cooling system is provided in place of a heating system at the heat exchanger (e.g., heat exchanger 35).

In the VAGMED Reversal process a hot feed source 114 (e.g., thermal brines, power plant condensers, boilers blow-down, hot or geothermal springs, wastewater of incinerators) enters the evaporator 157a of the last module 150a. As in the aforementioned systems the evaporator 157a includes a flow channel and an outer evaporation surface 161a. The evaporators 157 can include or be made of a micro-porous hydrophobic membrane as above. The module 150a can also include a condenser 152a having a condensation surface 155a, as above. The condensers 152 can be formed of condensation bundle tubes, as illustrated for example in FIGS. 6A-6H. The temperature difference created by the temperature of the hot feed source 114 as well as the vacuum applied within the enclosure of module 150a causes part of the feed to evaporate (the driving force is created by the pressure difference between the two sides of the hydrophobic membrane) where the condensable gases (water vapor) pass through the membrane pores to reach the condensation surface 155a of condenser 152a. Condensation takes place within the gap 123 between the hydrophobic membrane of the evaporation surface 161a and the condensation surface 155a. After losing some mass due to evaporation that also causes a drop in its temperature, the feed 114 enters the evaporator of the next module where the vacuum inside the module enclosure is adjusted to be slightly lower than the saturation pressure of the feed temperature to generate further condensable gases (water vapor). The feed 114 continues in similar manner until it exits the evaporator 157c of the first module 150c.

To ensure a constant temperature difference between the evaporation and condensation surfaces in all modules, its temperature is further cooled by 3-7° C. in a heat exchanger 135 by a cooling medium such as (ambient seawater, cold water from cooling tower or air-fan cooler). The cooled feed stream 119 exiting heat exchanger 135 then enters the channels of the condenser 157c of the first module 150c as a coolant to recover the latent heat of the vapor that condenses on the condensation surface 155c of that module. Then, it flows to the next module (before last) to recover more energy in similar manner and so on. The number of modules can be determined through specific designs depending on the plant size and the operating parameters, such as feed/coolant inlet temperatures, flow rates, module length, and hydrophobic membranes specs. The feed stream 119 exits the last module 150a as concentrated feed (for example concentrated brine) where it can be passed to storage tank 169 and if desired, as hot brine feed 214 for a next similar unit/process to be further treated in a similar manner, for example delivery to the inlet of evaporator 257a of module 250a.

The number of units/processes in series depends on the temperature of the brine discharged from the last unit/process, which in its turn depends on the available hot feed stream (a sufficient ΔT is required to drive the process). The maximum distillate production from the VAGMED (theoretically the product is distilled water quality as pure vapor is condensed only if no membrane pore wetting occurs) depends on the temperature difference between the hot feed that enters the first module and the brine temperature that exits the process, and the feed flow rate that enters the evaporation section of each process according to the following equation:

$${M}_{D} = \frac{{M}_{F 1} ( {T}_{F 1} - {T}_{B 1} )}{( \frac{{h}_{g}}{{C}_{p}} - {T}_{B 2} )} + \frac{{M}_{F 2} ( {T}_{F 2} - {T}_{B 2} )}{( \frac{{h}_{g}}{{C}_{p}} - {T}_{B 2} )} + … + \frac{{M}_{Fn} ( {T}_{Fn} - {T}_{Bn} )}{( \frac{{h}_{g}}{{C}_{p}} - {T}_{Bn} )}$$

where M_{D} and M_{F} are the mass flow rates of the distillate and heat feed, respectively, T_{F} and T_{B} are the temperatures of the heated feed that enters the first module and exits the last module, respectively, h_{g} and Cₚ are the average enthalpy of the generated water vapor and the average specific heat of the feed, respectively.

In the VAGMED reversal process (FIG. 8), the energy consumption is significantly lower, as cooling medium is required rather than the need for energy intensive heat source to achieve TBT as it is the case for conventional systems. Since the system runs under constant, or almost constant, temperature difference between evaporation and condensation in all stages, the same value of the temperature difference is provided by the external cooling medium (typically a low decrease of 3-10° C.).

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

1. A membrane distillation module, comprising:
a) a condenser including a condensation surface;
b) a first passageway having an inlet for receiving a first feed stream and an outlet through which the first stream can pass out of the first passageway, the first passageway configured to bring the first feed stream into thermal communication with the condensation surface;
c) an evaporator including a permeable evaporation surface allowing condensable gas to pass there through;
d) a second passageway having an inlet for receiving a second feed stream and an outlet through which the second feed stream can pass out of the second passageway, the second passageway configured to bring the second feed stream into communication with the permeable evaporation surface;
e) an enclosure providing a vacuum compartment within which the condenser, the evaporator and the first and second passageways of the module are contained; and
f) a vacuum system coupled to the vacuum compartment of the enclosure.

2. The membrane distillation module of claim 1, wherein the vacuum system is configured to control the pressure within the vacuum compartment of the module by adjusting the amount of vacuum applied to the vacuum compartment of the module relative to the saturation pressure of the second feed stream in the module and to remove uncondensed gas from the vacuum compartment.

3. The membrane distillation module of claim 1, wherein the first feed stream is selected from the group consisting of seawater, brine solution, industrial waste water, produced water, brackish water and non-potable water and the condensable gas is water vapor.

4. The membrane distillation module of claim 1, wherein the first feed stream or the second stream, or both, are de-gasified to remove non-condensable gas from the first feed stream or the second feed stream, or both, prior to being delivered to the module.

5. The membrane distillation module of claim 1, wherein either the first feed stream or the second feed stream, or both, includes a salt, a mixture of a salt and an organic contaminant, or a mixture of a salt and an inorganic contaminant.

6. The membrane distillation module of claim 1, wherein the first feed stream is a cold feed stream relative to temperature of the second feed stream or the first feed stream is cooled to have a colder temperature relative to the temperature of the second feed stream prior to being delivered to the inlet of the first passageway of the module.

7. The membrane distillation module claim 6, wherein the first feed stream after exiting the first passageway of the module is heated to form the second feed stream and then delivered to the inlet of the second passageway of the evaporator of the module.

8. The method of claim 1, wherein the second feed stream is a hot feed stream relative to the temperature of the first feed stream or the second feed stream is heated to have a hotter temperature relative to the temperature of the first feed stream prior to being delivered to the inlet of the second passageway of the module.

9. The membrane distillation module of claim 8, wherein the second feed stream after exiting the module is cooled to form the first feed stream and then delivered to the inlet of the first passageway of the module.

10. (canceled)

11. (canceled)

12. The membrane distillation module of claim 1, wherein the pressure within the vacuum compartment of the module is configured to be about 1% to about 5% below the saturation pressure of the second feed stream passed to the inlet of the second passageway of the evaporator of the module.

13. (canceled)

14. (canceled)

15. A system including a plurality of membrane distillation modules, each of the plurality of membrane distillation modules comprising the membranedistillation module of claim 1, the plurality of the membrane distillation modules coupled in series such that the outlet of the first passageway of one of the plurality of modules is coupled to the inlet of the first passageway of another of the plurality of modules and the inlet of the second passageway of the one of the plurality of modules is coupled to the outlet of the second passageway of the another of the plurality of modules, or vice versa, and wherein the second feed stream incurs a reduction in temperature due to evaporation of condensable gas from the second feed stream within the second passageway of each module of the plurality of membrane distillation modules and the number of modules of the plurality of membrane distillation modules is determined based on including a module of the plurality of the membrane distillation modules for every 2-3° C. or more reduction in the temperature of the second feed stream in each of the modules.

16. (canceled)

17. The system of claim 15, wherein the first stream exiting the outlet of the first passageway of one of the modules is heated to form the second feed stream and then delivered to the inlet of the second passageway of another one of the plurality of modules, or the second stream exiting the outlet of the second passageway of the another one of the plurality of modules is cooled to form the first stream and then delivered to the inlet of the first passageway of the one of the modules.

18. A method of membrane distillation, comprising the steps of:
a) providing a module, the module including a condenser and an evaporator, the condenser of the module including a condensation surface, the evaporator of the module including a permeable evaporation surface allowing condensable gas to pass there through, a first passageway having an inlet for receiving a first feed stream and an outlet through which the first feed stream can pass out of the first passageway, the first passageway configured to bring the first feed stream into thermal communication with the condensation surface, and a second passageway having an inlet for receiving a second feed stream and an outlet through which the second feed stream can pass out of the second passageway, the module including an enclosure providing a vacuum compartment within which the condenser, the evaporator and the first and second passageways of the module are contained, wherein the vacuum compartment of the module is coupled to a vacuum system;
b) providing a first feed stream to the inlet of the first passageway of the condenser of the module;
c) cooling the condensation surface of the condenser of the module with the first feed stream;
d) passing the first feed stream out of the outlet of the first passageway of the module;
e) passing a second feed stream to the inlet of the second passageway of the module;
f) evaporating condensable gas from the second feed stream and passing the condensable gas formed through the evaporation surface of the evaporator of the module;
g) condensing the condensable gas on the condensation surface of the condenser within the module;
h) passing the second feed stream out of the second passageway of the module; and
i) using the vacuum system to control the pressure within the vacuum compartment of the module by adjusting the amount of vacuum applied to the vacuum compartment of the module relative to the saturation pressure of the second feed stream in the second passageway of the module.

19. The method of claim 18, wherein the first feed stream is selected from the group consisting of seawater, brine solution, industrial waste water, produced water, brackish water and non-potable water and the condensable gas is water vapor.

20. (canceled)

21. The method of claim 18, wherein the first feed stream or the second feed stream, or both, includes a salt, a mixture of a salt and an organic contaminant or a mixture of a salt and an inorganic contaminant.

22. The method of claim 21, wherein the first feed stream is a cold feed stream relative to temperature of the second feed stream or the first feed stream is cooled to have a colder temperature relative to the temperature of the second feed stream prior to being delivered to the inlet of the first passageway of the module.

23. The method of claim 22, wherein the first feed stream after exiting the first passageway of the module is heated to form the second feed stream and then delivered to the inlet of the second passageway of the module.

24. (canceled)

25. (canceled)

26. (canceled)

27. (canceled)

28. The method of claim 18, wherein the vacuum system is used to control the pressure within the vacuum compartment of the module to be about 1% to about 5% below the saturation pressure of the second feed stream passed to the inlet of the second passageway of the module.

29. (canceled)

30. (canceled)

31. The method of claim 18, wherein a plurality of membrane distillation modules are provided, each of the plurality of membrane distillation modules comprising said module, the plurality of modules coupled in series such that the outlet of the first passageway of one of the plurality of modules is coupled to the inlet of the first passageway of another of the plurality of modules and the inlet of the second passageway of the one of the plurality of modules is coupled to the outlet of the second passageway of the another of the plurality of modules, or vice versa, and wherein the second feed stream incurs a reduction in temperature due to evaporation of condensable gas from the second feed stream within the second passageway of each said module of the plurality of membrane distillation modules and the number of modules of the plurality of membrane distillation modules is determined based on including a module of the plurality of membrane distillation modules for every 2-3° C. or more reduction in the temperature of the second feed stream in each of the membrane distillation modules.

32. (canceled)

33. The method of claim 31, including: passing the first feed stream to the inlet of the first passageway of one of the modules, passing the first feed stream out of the outlet of the first passageway of the one of the modules, delivering the first feed stream to the inlet of the second passageway of another of the modules to serve as the second feed stream, passing the second feed stream through the second passageway of the another module and passing the second feed stream out of the outlet of the second passageway of the another of the modules; or passing the second stream to the inlet of the second passageway of the another of the modules, passing the second stream out of the outlet of the second passageway of the another of the modules, delivering the second stream to the inlet of the first passageway of the one of the modules to serve as the first stream, passing the first stream through the first passageway of the one of the modules and passing the first stream out of the outlet of the first passageway of the one of the modules, and wherein the first feed stream after exiting the outlet of the first passageway of one of the modules is heated to form the second feed stream and then delivered to the inlet of the second passageway of another one of the plurality of modules, or the second steam exiting the outlet of the second passageway of the another one of the plurality of modules is cooled to form the first stream and then delivered to the inlet of the first passageway of the one of the modules.

34. (canceled)
